(19) United States
(12) Patent Application Publication
(10) Pub. No.: US 2024/0301221 A1
(43) Pub. Date: Sep. 12, 2024

(54) Coating Liquid Composition For Pigment Printing, Recording Method, And Recorded Product

(71) Applicant: SEIKO EPSON CORPORATION, Tokyo (JP)

(72) Inventors: Yoshitaka MIYAJIMA, Matsumoto (JP); Tetsuhiro OGUCHI, Okaya (JP); Takuya SONOYAMA, Fujimi (JP)

(21) Appl. No.: 18/596,847

(22) Filed: Mar. 6, 2024

(30) Foreign Application Priority Data
Mar. 7, 2023 (JP) 2023-034716

(51) Int. Cl. C09D 11/023; B41M 5/00; B41M 7/00; C09D 11/102; C09D 11/54; D06P 1/52; D06P 1/90; D06P 5/00

(52) U.S. Cl. CPC C09D 11/023; B41M 5/0017; B41M 7/009; C09D 11/102; C09D 11/54; D06P 1/5292; D06P 1/90; D06P 5/002

(57) ABSTRACT

A coating liquid composition for pigment printing includes emulsified particles containing a silicone oil, and water. The content of the emulsified particles is more than 15.0% by mass based on the total amount of the coating liquid composition for pigment printing.

The present application is based on, and claims priority from JP Application Serial Number 2023-034716, filed Mar. 7, 2023, the disclosure of which is hereby incorporated by reference herein in its entirety.

### BACKGROUND

### 1. Technical Field

The present disclosure relates to a coating liquid composition for pigment printing, a recording method, and a recorded product.

### 2. Related Art

An ink jet recording method is capable of recording high-resolution images with a relatively simple apparatus, and is rapidly developing in various fields. In particular, various studies have been made to improve the coloration of a pigment. For example, JP-A-2020-019173 discloses a treatment liquid composition for use on a fabric, comprising a cationic compound, a water-soluble resin, and water. The molecular weight distribution of the water-soluble component, contained in the treatment liquid composition, has a maximum in the molecular-weight range of 28,000 to 2,800,000. Further, the content of the water-soluble resin having a molecular weight of 28,000 to 2,800,000 is 0.6 to 5.0% by mass based on the total amount of the treatment liquid composition.

However, it was found that there is room for improvement in the coloration of a pigment when it is used together with the treatment liquid composition described in the above patent document.

### SUMMARY

According to an aspect of the present disclosure, a coating liquid composition for pigment printing includes emulsified particles containing a silicone oil, and water. The content of the emulsified particles is more than 15.0% by mass based on the total amount of the coating liquid composition for pigment printing.

### BRIEF DESCRIPTION OF THE DRAWINGS

FIGS. 1A through 1D are tables showing the results of Examples.

FIGS. 2A through 2D are tables showing the results of Examples.

### DESCRIPTION OF EMBODIMENTS

An embodiment of the present disclosure (hereinafter referred to as “this embodiment”) will now be described in detail. It should be noted that the present disclosure is not limited to the embodiment, and various changes and modifications can be made to the embodiment without departing from the spirit and scope of the present disclosure.

### 1. Coating Liquid Composition for Pigment Printing

The coating liquid composition for pigment printing according to this embodiment (hereinafter also referred to simply as “the coating liquid composition”) is a coating liquid composition for pigment printing, comprising emulsified particles containing a silicone oil, and water. The content of the emulsified particles is more than 15.0% by mass based on the total amount of the coating liquid composition for pigment printing.

When a dye is used in a printing process, a steam-cleaning step is required after printing. The steam-cleaning step is not necessary when a pigment is used instead of a dye. The use of a pigment in a printing process is therefore preferred from the viewpoint of cost saving and a reduction of environmental burden.

However, a pigment tends to be low in coloration as compared to a dye. The tendency is pronounced when a black pigment is used. In order to improve the coloration of a pigment, measures are taken, such as pre-treating a recording medium, increasing the amount of an ink applied upon printing, etc.; however, there is room for improvement in the coloration.

In this embodiment, a recording medium is subjected to a post-printing treatment using a coating liquid composition for pigment printing, comprising emulsified particles containing a silicone oil, and water, wherein the content of the emulsified particles is more than 15.0% by mass based on the total amount of the coating liquid composition for pigment printing. The treatment tends to improve the coloration of a pigment used for the printing. The improvement in the coloration may be because of the following reasons. The emulsified particles containing a silicone oil cover the surfaces of pigment particles, thereby smoothing surface irregularities of the pigment particles and reducing diffuse reflection of light caused by the surface irregularities. Further, the surface of the recording medium is smoothed by the application of the silicone oil-containing emulsified particles onto the recording medium. This reduces diffuse reflection of light caused by fuzz on the recording medium. In addition, a film comprising the silicone oil-containing emulsified particles has a lower refractive index than the recording medium. This reduces the intensity of specular light. It is to be noted, however, that the reasons for the improvement in the coloration are not limited to the above-described ones.

The dry rub fastness of a recording medium is enhanced by subjecting the recording medium to a post-printing treatment using the coating liquid composition of this embodiment. This may be because the slip properties of the surface of the recording medium are enhanced by covering it with the coating liquid composition. It is to be noted, however, that the reason for the enhancement of the dry rub fastness is not limited to the above-described one.

Further, the wet rub fastness of a recording medium is enhanced by subjecting the recording medium to a post-printing treatment using the coating liquid composition of this embodiment. This may be because the surface of the recording medium is made water-repellent by covering it with the coating liquid composition, so that the slip properties of the surface of the recording medium can be maintained even in a humid environment. It is to be noted, however, that the reason for the enhancement of the wet rub fastness is not limited to the above-described one.

The respective components of the coating liquid composition of this embodiment will now be described in detail.

### 1.1. Emulsified Particles

As described above, there is room for improvement in the coloration of a pigment in printing using the pigment. According to this embodiment, the inclusion of emulsified particles containing a silicone oil in the coating liquid composition tends to achieve excellent coloration of a pigment. The emulsified particles may be of a single type or two or more different types. The content of the emulsified particles herein refers to a value that does not include the content of a dispersion medium.

The silicone oil is not particularly limited and may be, for example, a linear or cyclic silicone oil. The linear silicone oil is not particularly limited and may be, for example, a linear unmodified silicone oil or a linear modified silicone oil. The silicone oil may be of a single type or two or more different types.

The linear unmodified silicone oil is not particularly limited. Examples thereof include a dimethyl silicone oil, a methylphenyl silicone oil, and a methyl hydrogen silicone oil.

The linear modified silicone oil is not particularly limited and may be, for example, one obtained by modifying the above-described linear unmodified silicone oil with an alkyl, aralkyl, polyether, higher fatty acid ester, higher fatty acid amide, fluoroalkyl, amino, epoxy, carboxy, alcohol, phenyl, carbinol, methacrylic, mercapto, silanol, acrylic, or diol group.

The cyclic silicone oil is not particularly limited and may be, for example, a cyclic dimethylsiloxane oil such as a hexamethylcyclotrisiloxane oil, an octamethylcyclotetrasiloxane oil, or a decamethylcyclopentasiloxane oil.

Among them, a linear modified silicone oil is preferred, and an amino-modified silicone oil is more preferred. The amino-modified silicone oil is not particularly limited and may be, for example, “siloxane and silicone, {3-[(2-aminoethyl)amino]propyl}methyl-dimethyl-, hydroxy-terminated” (CAS: 75718-16-0).

The content of the silicone oil is preferably 60.0 to 98.0% by mass, more preferably 65.0 to 95.0% by mass, even more preferably 70.0 to 90.0% by mass, and still more preferably 72.5 to 87.5% by mass based on the content of the emulsified particles. The use of the emulsified particles, containing a silicone oil in an amount within the above ranges, tends to improve the coloration of a pigment.

The content of the silicone oil is preferably 7.5 to 40.0% by mass, more preferably 9.0 to 35.0% by mass, even more preferably 10.0 to 30.0% by mass, still more preferably 10.5 to 27.5% by mass, yet more preferably 11.0 to 25.0% by mass, yet more preferably 11.5 to 22.5% by mass, and most preferably 12.0 to 20.0% by mass based on the total amount of the coating liquid composition. The use of the emulsified particles, containing a silicone oil in an amount within the above ranges, tends to improve the coloration of a pigment and enhance the dry rub fastness and wet rub fastness of a recording medium.

The content of the emulsified particles is more than 15.0% by mass, preferably more than 15.0% by mass and not more than 60.0% by mass, more preferably more than 15.0% by mass and not more than 50.0% by mass, even more preferably more than 15.0% by mass and not more than 40.0% by mass, still more preferably 15.5 to 35.0% by mass, yet more preferably 16.0 to 30.0% by mass, yet more preferably 16.0 to 27.5% by mass, and most more preferably 16.5 to 25.0% by mass based on the total amount of the coating liquid composition. The use of the emulsified particles in an amount within the above ranges tends to improve the coloration of a pigment and enhance the dry rub fastness and wet rub fastness of a recording medium. In addition, the use of the coating liquid composition, containing the emulsified particles in an amount within the above ranges, on a washable recording medium such as a fabric, a knit, or a nonwoven fabric tends to achieve both appropriate water repellency and washability.

The emulsified particles are not particularly limited. For example, besides the above-described silicone oil, the emulsified particles may optionally contain additives, such as an organic solvent, a surfactant, and a viscosity modifier, as components constituting the emulsified particles.

The organic solvent is not particularly limited and may be, for example, one or two or more selected from the organic solvents listed below.

The content of the organic solvent is preferably 0.1 to 15.0% by mass, more preferably 0.5 to 14.0% by mass, even more preferably 1.0 to 13.0% by mass, still more preferably 2.5 to 12.5% by mass, and yet more preferably 5.0 to 12.0% by mass based on the content of the emulsified particles.

The surfactant is not particularly limited and may be, for example, an acetylene glycol surfactant, a fluorinated surfactant, a polysiloxane surfactant, or a higher alcohol surfactant. The surfactant may be of a single type or two or more different types.

The acetylene glycol surfactant is not particularly limited. Examples thereof include 2,4,7,9-tetramethyl-5-decyne-4,7-diol, an alkylene oxide adduct of 2,4,7,9-tetramethyl-5-decyne-4,7-diol, 2,4-dimethyl-5-decyne-4-ol, and an alkylene oxide adduct of 2,4-dimethyl-5-decyne-4-ol.

The fluorinated surfactant is not particularly limited. Examples thereof include a perfluoroalkyl sulfonate, a perfluoroalkyl carboxylate, a perfluoroalkyl phosphate, a perfluoroalkyl ethylene oxide adduct, a perfluoroalkyl betaine, and a perfluoroalkylamine oxide compound.

The polysiloxane surfactant is not particularly limited and may be, for example, a polysiloxane compound or a polyether-modified organosiloxane.

The higher alcohol surfactant is not particularly limited. Examples thereof include heptanol, methoxylated heptanol, ethoxylated heptanol, propoxylated heptanol, octanol, methoxylated octanol, ethoxylated octanol, propoxylated octanol, nonanol, methoxylated nonanol, ethoxylated nonanol, propoxylated nonanol, decanol, methoxylated decanol, ethoxylated decanol, propoxylated decanol, isotridecanol, methoxylated isotridecanol, ethoxylated isotridecanol, propoxylated isotridecanol, stearyl alcohol, methoxylated stearyl alcohol, ethoxylated stearyl alcohol, propoxylated stearyl alcohol, oleyl alcohol, methoxylated oleyl alcohol, ethoxylated oleyl alcohol, and propoxylated oleyl alcohol.

The content of the surfactant is preferably 0.1 to 15.0% by mass, more preferably 1.0 to 14.0% by mass, even more preferably 2.5 to 13.0% by mass, and still more preferably 5.0 to 12.5% by mass based on the content of the emulsified particles.

### 1.2. Organic Solvent

The coating liquid composition of this embodiment may contain an organic solvent. The organic solvent is not particularly limited and may be, for example, a water-soluble organic solvent such as a water-soluble monohydric alcohol, a polyol, or a glycol ether; or a water-insoluble organic solvent such as a hydrocarbon solvent, a higher fatty acid ester solvent, a higher fatty acid solvent, or a higher alcohol solvent. The organic solvent may be of a single type or two or more different types.

The water-soluble monohydric alcohol is not particularly limited. Examples thereof include methanol, ethanol, 1-propanol, isopropanol, 1-butanol, 2-butanol, isobutanol, and 2-methyl-2-propanol.

The polyol is not particularly limited. Examples thereof include diols such as ethylene glycol, diethylene glycol, triethylene glycol, tetraethylene glycol, pentaethylene glycol, propylene glycol, dipropylene glycol, tripropylene glycol, tetrapropylene glycol, 1,3-propanediol, 1,2-butanediol, 1,3-butanediol, 1,2-pentanediol, 1,2-hexanediol, 1,4-butanediol, 1,5-pentanediol, and 1,6-hexanediol; triols such as 1,2,5-hexanetriol, 1,2,6-hexanetriol, polyoxypropylenetriol, and glycerin; and tetraols such as pentaerythritol.

The glycol ether is not particularly limited. Examples thereof include triethylene glycol monomethyl ether, triethylene glycol dimethyl ether, triethylene glycol monobutyl ether, diethylene glycol monobutyl ether, and dipropylene glycol monopropyl ether.

The hydrocarbon solvent is not particularly limited and may be, for example, a naphthenic, paraffinic, or isoparaffinic hydrocarbon solvent.

The higher fatty acid ester solvent is not particularly limited and may be, for example, one having 5 or more carbon atoms, in particular 10 or more carbon atoms, in one molecule. Examples of such a solvent include isopropyl palmitate, hexyl palmitate, isooctyl palmitate, isostearyl palmitate, isooctyl isopalmitate, butyl stearate, hexyl stearate, isooctyl stearate, isopropyl isostearate, 2-octyldodecyl pivalate, methyl laurate, isopropyl laurate, isopropyl myristate, methyl oleate, ethyl oleate, isopropyl oleate, butyl oleate, hexyl oleate, methyl linoleate, ethyl linoleate, isobutyl linoleate, diisopropyl adipate, diisopropyl sebacate, diethyl sebacate, propylene glycol monocaprate, trimethylolpropane tris(2-ethylhexanoate), and glyceryl tris(2-ethylhexanoate).

The higher fatty acid solvent is not particularly limited and may be, for example, one having 7 or more carbon atoms, in particular 10 or more carbon atoms, in one molecule. Examples of such a solvent include heptanoic acid, octanoic acid, nonanoic acid, decanoic acid, dodecanoic acid, tetradecanoic acid, hexadecanoic acid, isopalmitic acid, oleic acid, and stearic acid.

The higher alcohol solvent is not particularly limited and may be, for example, one having 7 or more carbon atoms, in particular 10 or more carbon atoms, in one molecule, or an alkoxylated product thereof. Examples of such a solvent include heptanol, methoxylated heptanol, ethoxylated heptanol, propoxylated heptanol, octanol, methoxylated octanol, ethoxylated octanol, propoxylated octanol, nonanol, methoxylated nonanol, ethoxylated nonanol, propoxylated nonanol, decanol, methoxylated decanol, ethoxylated decanol, propoxylated decanol, isotridecanol, methoxylated isotridecanol, ethoxylated isotridecanol, propoxylated isotridecanol, stearyl alcohol, methoxylated stearyl alcohol, ethoxylated stearyl alcohol, propoxylated stearyl alcohol, oleyl alcohol, methoxylated oleyl alcohol, ethoxylated oleyl alcohol, and propoxylated oleyl alcohol.

The content of the organic solvent is preferably 0.0 to 15.0% by mass, more preferably 0.0 to 12.5% by mass, even more preferably 0.0 to 10.0% by mass, and still more preferably 0.0 to 7.5% by mass based on the total amount of the coating liquid composition. Such a content of the organic solvent tends to improve the coloration of a pigment.

### 1.3. Crosslinking Agent

The coating liquid composition of this embodiment may contain a crosslinking agent. The inclusion of a crosslinking agent in the coating liquid composition tends to increase the strength of an overcoat layer formed from the coating liquid composition, and to enhance the dry rub fastness and the wet rub fastness.

The crosslinking agent is not particularly limited and may be, for example, an isocyanate crosslinking agent, an oxazoline crosslinking agent, or a carbodiimide crosslinking agent. The crosslinking agent may be of a single type or two or more different types.

The isocyanate crosslinking agent is not particularly limited and may be, for example, a compound having two or more isocyanate groups in one molecule. Examples of such a compound include an aliphatic polyisocyanate, an alicyclic polyisocyanate, an aromatic polyisocyanate, araliphatic polyisocyanate, and a derivative thereof (e.g., a derivative in which the isocyanate groups have been converted into blocked isocyanate groups). A commercially available product may be used, such as “OXAL XS” (containing blocked isocyanate groups), manufactured by Epson Como Printing Technologies S.r.l.

The oxazoline crosslinking agent is not particularly limited and may be, for example, a polymer obtained by homopolymerization of an oxazoline group-containing ethylenically unsaturated monomer, such as 2-isopropenyl-2-oxazoline or 2-vinyl-2-oxazoline, or copolymerization of such a monomer with other unsaturated monomer (s). The oxazoline crosslinking agent may be a commercially available product such as “Epocross WS500” or “Epocross K201E”, manufactured by Nippon Shokubai Co., Ltd.

The carbodiimide crosslinking agent is not particularly limited and may be, for example, a compound having two or more carbodiimide groups in one molecule. The carbodiimide crosslinking agent may be a commercially available product such as “Carbodilite V-02” manufactured by Nisshinbo Chemical Inc.

The content of the crosslinking agent is preferably 0.1 to 10.0% by mass, more preferably 0.5 to 7.5% by mass, and even more preferably 1.0 to 5.0% by mass based on the total amount of the coating liquid composition. The use of the crosslinking agent in an amount within the above ranges tends to enhance the dry rub fastness and wet rub fastness of a recording medium.

### 1.4. Water

The water contained in the coating liquid composition of this embodiment is not particularly limited and may be, for example, ion-exchanged water, ultrafiltrated water, reverse osmosis water, or distilled water.

The content of water is preferably 60.0 to 90.0% by mass, more preferably 65.0 to 80.0% by mass based on the total amount of the coating liquid composition.

### 1.5. Other Components

Besides the above-described components, the coating liquid composition of this embodiment may contain any other known components that can be used in conventional coating liquid compositions. There is no particular limitation on such other components. Examples thereof include a polymerization initiator, a polymerizable compound, a solubilizer, a viscosity modifier, a pH adjuster, an antioxidant, a preservative, a corrosion inhibitor, a chelating agent or the like for capturing particular metal ions that affect dispersion, and an organic solvent other than those described above. Such other components may be used singly or in a combination of two or more.

### 2. Ink Composition

The coating liquid composition of this embodiment is, for example, coated onto an image formed on the below-described recording medium to form an overcoat layer. The formation of the image is performed, for example, by printing of an ink composition onto the recording medium.

The ink composition is not particularly limited. The ink composition may contain, for example, a colorant such as a dye or a pigment; a resin such as a urethane resin, an acrylic resin, a fluorene resin, a polyolefin resin, a rosin-modified resin, a terpene resin, a polyester resin, a polyamide resin, an epoxy resin, a vinyl chloride resin, or an ethylene-vinyl acetate resin; an organic solvent such as a monohydric alcohol, a polyol, or a glycol ether; and a surfactant such as an acetylene glycol surfactant, a fluorinated surfactant, or a polysiloxane surfactant, and may further contain water as necessary. When the ink composition is to be cured by light, it may further contain, for example, a polymerization initiator such as an aromatic ketone or an acylphosphine oxide compound; a polymerization inhibitor such as hydroquinone or a hindered amine; and a polymerizable compound having a polymerizable functional group, such as a nitrogen-containing monomer such as N-vinyl caprolactam, an acrylate monomer such as dicyclopentenyl acrylate, an aromatic group-containing monomer such as a phenoxyethyl methacrylate monomer, or an aliphatic group-containing monomer such as tert-butylcyclohexanol acrylate.

The content of the colorant in the ink composition is not particularly limited and may be, for example, 1 to 20% by mass based on the total amount of the ink composition.

A recording method using the ink composition is not particularly limited and may be, for example, an ink jet recording method, a laser recording method, or a thermal transfer recording method.

The ink jet recording method is not particularly limited and may be, for example, an ink jet printing method. The ink jet printing method is performed using an ink jet recording apparatus. The ink jet recording apparatus may be one that includes a carriage equipped with a head having a line of nozzles, such as a drop-on-demand ink jet recording apparatus. The drop-on-demand ink jet recording apparatus may be, for example, one that employs an ink jet printing method using piezoelectric elements provided in the head, or one that uses a thermal energy from a heater comprised of a heating resistive element provided in the head.

### 3. Recoding Medium

There is no particular limitation on a recording medium for use in recording using the coating liquid composition of this embodiment; it may be, for example, an absorptive recording medium, a low-absorptive recording medium, or a non-absorptive recording medium.

The absorptive recording medium is not particularly limited and may be, for example, ordinary paper such as electrophotographic paper with high ink permeability, ink jet paper (paper exclusive for ink jet, having an ink absorption layer composed of silica particles or alumina particles, or an ink absorption layer composed of a hydrophilic polymer such as polyvinyl alcohol (PVA) or polyvinylpyrrolidone (PVP)), fabric, knit, or nonwoven fabric.

The low-absorptive recording medium is not particularly limited and may be, for example, art paper, coated paper, or cast-coated paper, which has a relatively low ink permeability and which is generally for use in offset printing.

The non-absorptive recording medium is not particularly limited. Examples thereof include a film or plate made of a plastic material such as polyvinyl chloride, polyethylene, polypropylene, polyethylene terephthalate (PET), polycarbonate, polystyrene, or polyurethane; a plate made of a metal such as iron, silver, copper, or aluminum; a metal plate, a plastic film, or a plate made of an alloy such as stainless steel or brass, having a vapor-deposited metal layer; and a recording medium composed of a paper substrate, and a film (coating) bonded (applied) to the substrate and made of a plastic material such as polyvinyl chloride, polyethylene, polypropylene, polyethylene terephthalate (PET), polycarbonate, polystyrene, or polyurethane.

The coating liquid composition of this embodiment is preferably used after printing on a fabric, knit, or nonwoven fabric so as to improve the coloration, dry rub fastness, and wet rub fastness of the fabric, knit, or nonwoven fabric. There is no particular limitation on the material of the fabric, knit, or non-woven fabric. Examples thereof include natural fibers such as cotton, hemp, wool, or silk; chemical fibers such as polyester, rayon, nylon, acrylic, or polyurethane; and a blended fabric produced using two or more types of fibers selected from the group consisting of the above-listed fibers (for example, a blended fabric of cotton and polyester).

When the material of the fabric, knit, or nonwoven material is a blended fabric, it is generally difficult to improve the coloration of a pigment. The use of the coating liquid composition of this embodiment tends to improve the coloration even when the material of the fabric, knit, or nonwoven material is a blended fabric.

### 4. Recording Method

A recording method using the coating liquid composition of this embodiment includes a coating step of applying the coating liquid composition onto the recording medium, and may optionally include other step (s) such as a pretreatment step of applying and attaching a pretreatment liquid to the recording medium before forming an image on the recording medium, and a drying step of drying the coating liquid composition after the coating step.

### 4.1. Coating Step

There is no particular limitation on the coating step of this embodiment. In an example, the coating liquid composition is applied onto an image formed on the recording medium. A method for applying the coating liquid composition is not particularly limited and may be, for example, a padding method, a dipping method, or an ink jet method.

### 4.2. Pretreatment Step

In the pretreatment step, a pretreatment liquid is applied and attached to the recording medium before an image is formed on the recording medium. The pretreatment step tends to improve the coloration of a pigment and enhance the dry rub fastness and wet rub fastness of the recording medium.

There is no particular limitation on a pretreatment liquid for use in the pretreatment step. An exemplary pretreatment liquid contains water and a reactant for coagulating or thickening components of an ink composition, such as a pigment and a resin. The reactant is not particularly limited and may be, for example, a polyvalent metal salt, an organic acid, or a cationic compound. The proportion of the reactant in the pretreatment liquid is not particularly limited and may be, for example, 1 to 20% by mass based on the total amount of the pretreatment liquid.

There is no particular limitation on a method for applying and attaching the pretreatment liquid to the recording medium in the pretreatment step. Exemplary methods include a method which involves immersing the recording medium in the pretreatment liquid, a method which involves applying the pretreatment liquid to the recording medium with a blade or a brush, a method which involves spraying the pretreatment liquid onto the recording medium, and a method which involves applying the pretreatment liquid to the recording medium using an ink jet recording apparatus.

### 4.3. Drying Step

The recording method using the coating liquid composition of this embodiment may include a drying step of drying the coating liquid composition after the coating step using, for example, a drying unit. The drying unit is not particularly limited and may be, for example, a platen heater, a hot air heater or an IR heater, having a heating function, or a blower having no heating function. The drying temperature may be, for example, 70° C. to 110° C. The inclusion of the drying step tends to enhance the dry rub fastness and wet rub fastness of the recording medium. When the coating liquid composition of this embodiment contains a crosslinking agent, a curing reaction such as a crosslinking reaction is likely to occur upon drying. This tends to enhance the dry rub fastness and wet rub fastness of the recording medium.

### 4.4. Other Steps

Besides the steps described above, the recording method using the coating liquid composition of this embodiment may include other step (s). Such other step (s) is not particularly limited. Examples thereof include a light irradiation step of irradiating the coating liquid composition, additionally containing a polymerization initiator and a polymerizable compound, with light to cure the coating liquid composition, a cleaning step of cleaning the recording medium after forming an overcoat layer on the recording medium from the coating liquid composition, and a preheating step of preheating the recording medium before forming an image on the recording medium.

### 5. Recorded Product

A recorded product, having an overcoat layer formed from the coating liquid composition of this embodiment and formed on an image formed on the recording medium, preferably has a diffuse reflectance of not less than 0% and less than 3% in the entire visible light range (wavelength 300 to 800 nm). The diffuse reflectance within the above range tends to improve the coloration of a pigment.

The diffuse reflectance can be measured by a known method using Kubelka-Munk's equation. More specifically, it can be measured using a spectrophotometer such as UV-3100 manufactured by Shimadzu Corporation.

The resolution of an image in the recorded product is not particularly limited and may be, for example, 100 to 2000 dpi, 150 to 1850 dpi, 200 to 1700 dpi, 250 to 1600 dpi, 250 to 1500 dpi, 300 to 1400 dpi, 400 to 1350 dpi, or 500 to 1300 dpi. The vertical and horizontal resolutions can be any combination of values within the above numerical ranges. For example, the vertical resolution may be 1200 dpi and the horizontal resolution may be 1200 dpi, or the vertical resolution may be 1200 dpi and the horizontal resolution may be 900 dpi, or the vertical resolution may be 1200 dpi and the horizontal resolution may be 600 dpi, or the vertical resolution may be 600 dpi and the horizontal resolution may be 900 dpi.

### EXAMPLES

The following examples illustrate the present disclosure in greater detail and are not intended to limit the scope of the disclosure. The below-described operations were carried out at room temperature (25° C.) and 105 Pa unless otherwise specified.

### 1. Preparation of Coating Liquid Composition

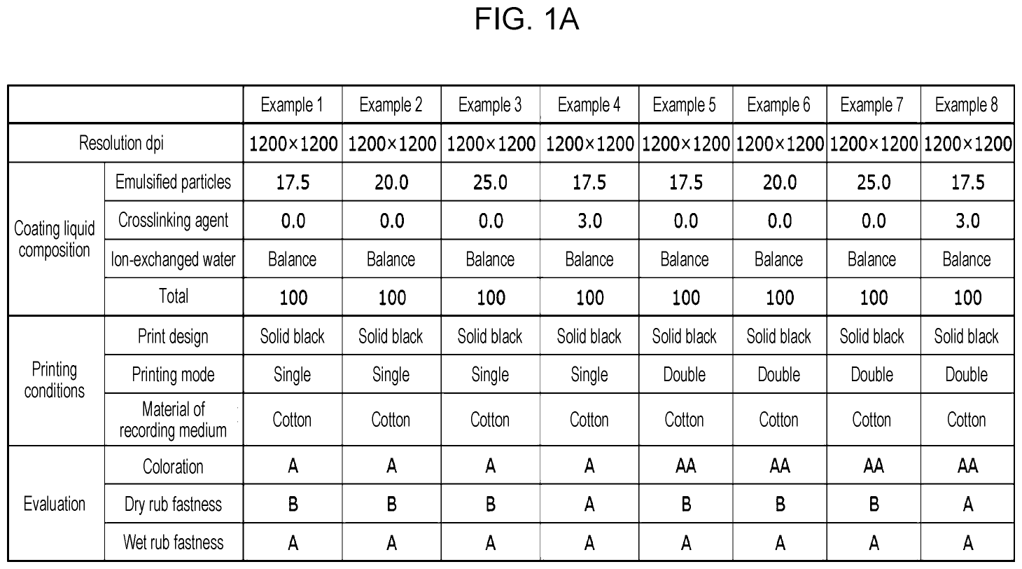

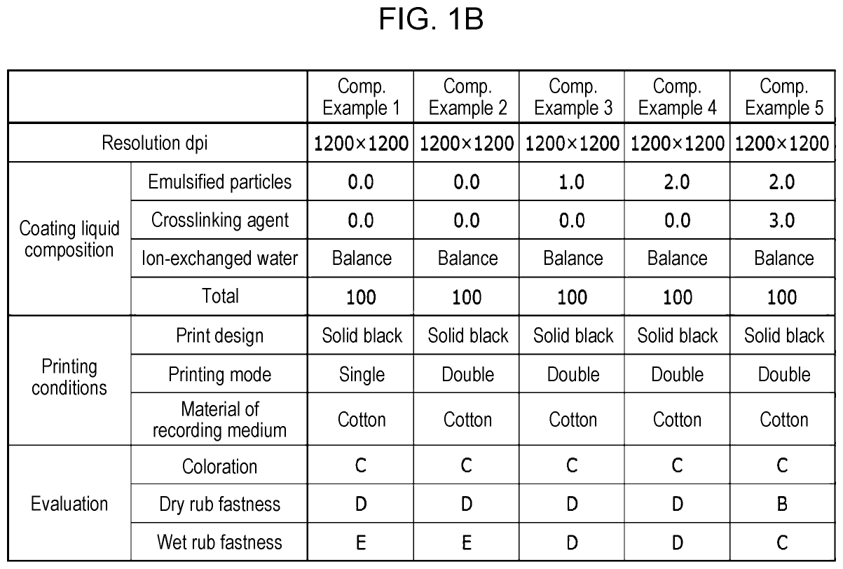

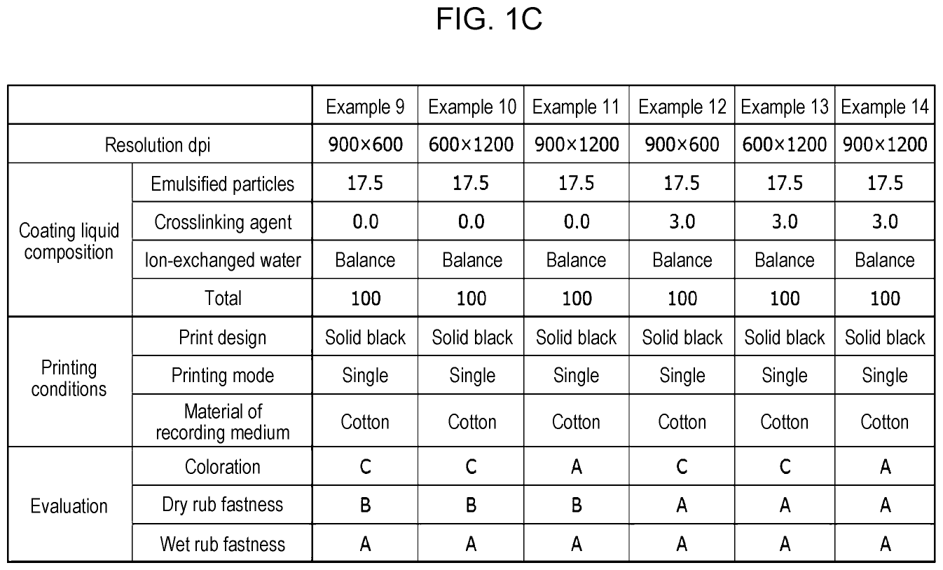

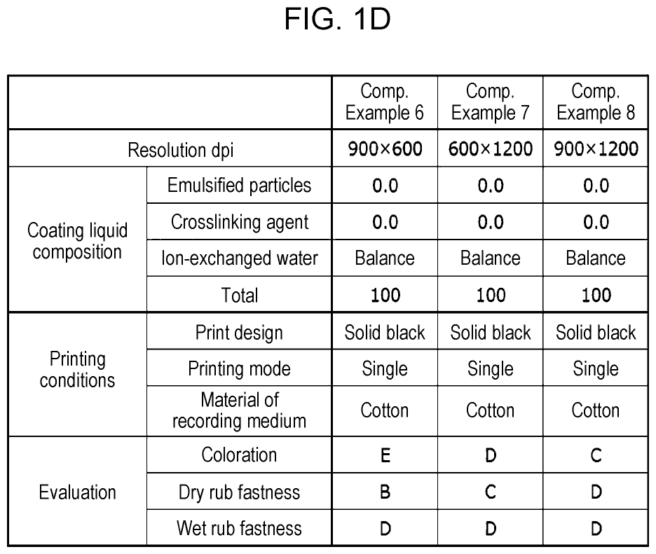

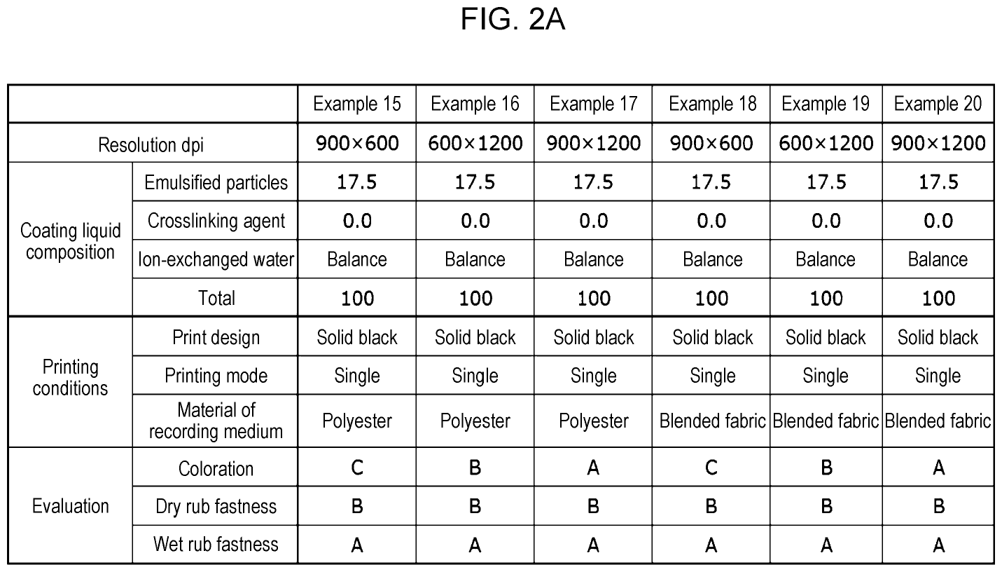

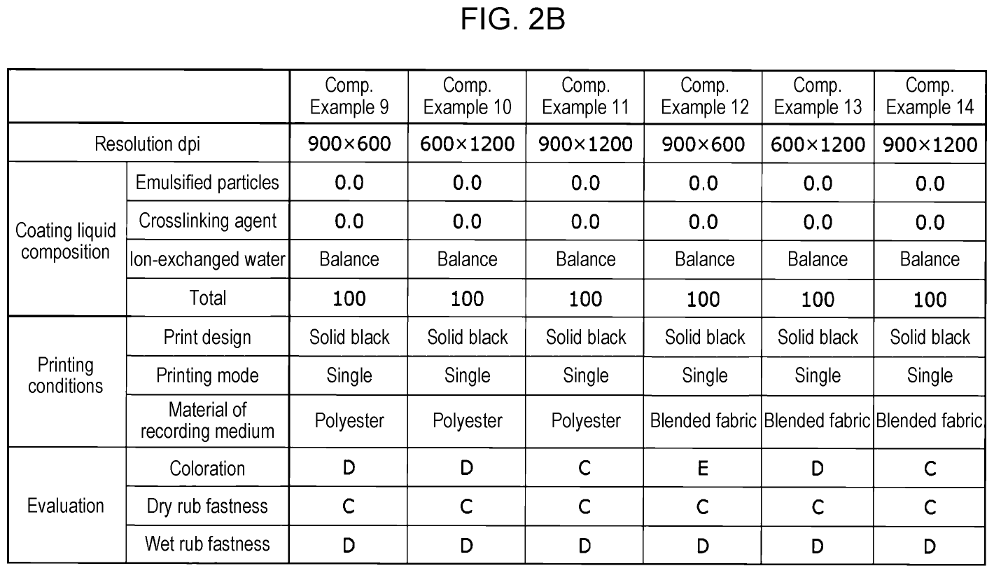

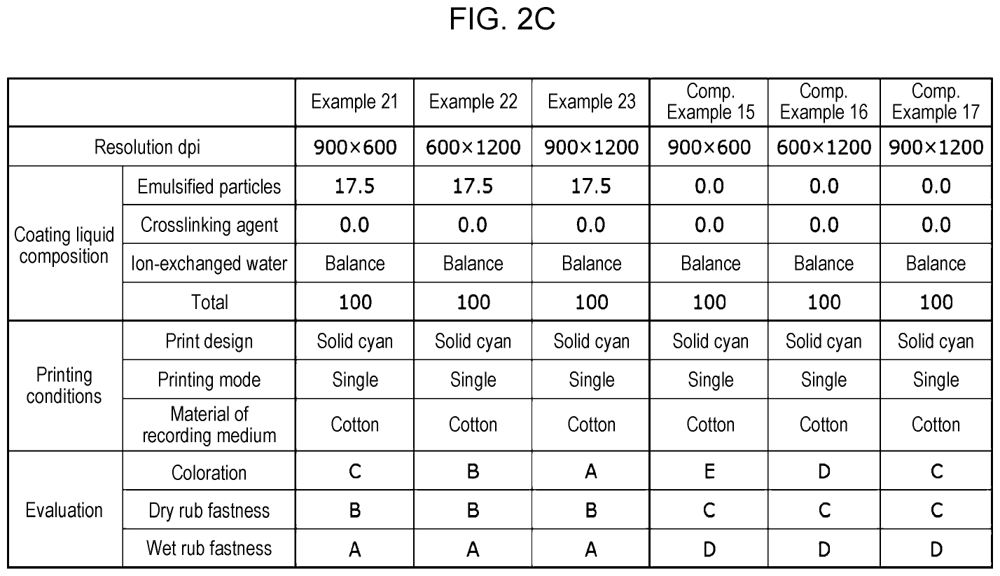

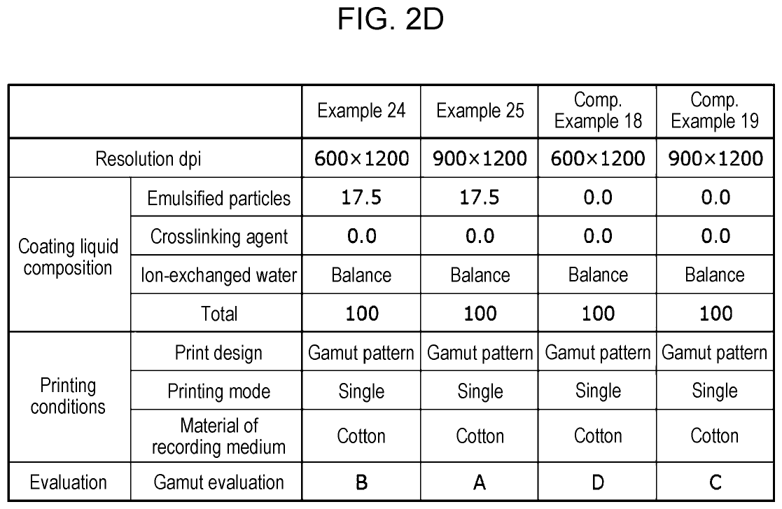

Components were placed in a mixture tank in such amounts as to meet each of the compositions shown in FIGS. 1A through 2D, and mixed and stirred to obtain a coating liquid composition of each of Examples and Comparative Examples. Unless otherwise specified, the numerical values for the components, shown in FIGS. 1A through 2D, each indicate the content (unit: mass %) based on 100% by mass of the coating liquid composition. The content of emulsified particles is that of the emulsified particles containing no ion-exchanged water as a dispersion medium.

### 2. Production of Recorded Product

Various print designs were printed on the recording media described in FIGS. FIGS. 1A through 2D under the printing conditions described in FIGS. FIGS. 1A through 2D using a printer Monna Lisa Evo Tre 16, equipped with commercially-available GENESTA pigment inks manufactured by Seiko Epson Corporation, followed by heating at 160° C. for 3 minutes. Subsequently, each coating liquid composition was applied at a uniform thickness to a recording medium by a padding method, followed by heating at 160° C. for 3 minutes to form an overcoat layer. Recorded products of Examples and Comparative Examples were thus produced. The terms “solid black” and “solid cyan” in the “print design” rows of the tables indicate solid printing of a black ink and solid printing of a cyan ink, respectively. The terms “single” and “double” in the “printing mode” rows of the tables indicate that the ink was ejected in an amount corresponding to one slot and two slots, respectively, of the ink.

The materials shown in FIGS. 1A through 2D are as follows.
Crosslinking agent (OXAL XS, blocked isocyanate group-containing crosslinking agent, manufactured by Epson Como Printing Technologies S.r.l.)
Ion-exchanged water

The emulsified particles were produced by mixing 49.9% by mass of “siloxane and silicone, {3-[(2-aminoethyl)amino]propyl}methyl-dimethyl-, hydroxy-terminated” (CAS: 75718-16-0), 9.9% by mass of ethoxylated isotridecanol (CAS: 69011-36-5), and 40.2% by mass of ion-exchanged water.

The blended fabric was made of 65% cotton and 35% polyester.

### 3. Evaluation

### 3.1. Coloration

The optical density (OD) values of the recorded products of Examples and Comparative Examples were measured using a colorimeter (Spectrolino manufactured by X-Rite, Inc.), and evaluated based on the following evaluation criteria.

### [Evaluation Criteria]

### (1) Print Design: Solid Black, Material of Recording Medium: Cotton

AA: OD value is more than 1.80.
A: OD value is more than 1.70 and not more than 1.80.
B: OD value is more than 1.60 and not more than 1.70.
C: OD value is more than 1.40 and not more than 1.60.
D: OD value is more than 1.30 and not more than 1.40.
E: OD value is not more than 1.30.

### (2) Print Design: Solid Black, Material of Recording Medium: Polyester

A: OD value is more than 1.60.
B: OD value is more than 1.50 and not more than 1.60.
C: OD value is more than 1.40 and not more than 1.50.
D: OD value is more than 1.30 and not more than 1.40.
E: OD value is not more than 1.30.

### (3) Print Design: Solid Black, Material of Recording Medium: Blended Fabric

A: OD value is more than 1.50.
B: OD value is more than 1.35 and not more than 1.50.
C: OD value is more than 1.20 and not more than 1.35.
D: OD value is more than 1.05 and not more than 1.20.
E: OD value is not more than 1.05.

(4) Print Design: Solid Cyan, Material of Recording Medium: Cotton
A: OD value is more than 1.50.
B: OD value is more than 1.35 and not more than 1.50.
C: OD value is more than 1.20 and not more than 1.35.
D: OD value is more than 1.05 and not more than 1.20.
E: OD value is not more than 1.05.

### 3.2. Dry Rub Fastness

A dry rub fastness test was conducted using a Gakushin-type rub fastness tester AB-301S, manufactured by Tester Sangyo Co., Ltd., by rubbing each recorded product 150 times at a load of 200 g. The dry rub fastness was determined according to Japanese Industrial Standards (JIS) JIS L0849 for checking the degree of peeling of the ink, and evaluated based on the following evaluation criteria.

### [Evaluation Criteria]

A: grade 3-4 or higher
B: grade 3 or higher and lower than grade 3-4
C: grade 2-3 or higher and lower than grade 3
D: grade 2 or higher and lower than grade 2-3
E: lower than grade 2

### 3.3. Wet Rub Fastness

A wet rub fastness test was conducted using a Gakushin-type rub fastness tester AB-301S, manufactured by Tester Sangyo Co., Ltd., by rubbing each recorded product 150 times at a load of 200 g. The wet rub fastness was determined according to Japanese Industrial Standards (JIS) JIS L0849 for checking the degree of peeling of the ink, and evaluated based on the following evaluation criteria.

### [Evaluation Criteria]

A: grade 3-4 or higher
B: grade 3 or higher and lower than grade 3-4
C: grade 2-3 or higher and lower than grade 3
D: grade 2 or higher and lower than grade 2-3
E: lower than grade 2

### 3.4. Gamut Evaluation

For the recorded products for gamut evaluation (Examples 24 and 25, and Comparative Examples 18 and 19), the coordinates of the L*a*b* color system of the color difference display method specified by CIE were measured using a colorimeter (Spectrolino manufactured by X-Rite, Inc.), and the gamut was calculated and evaluation based on the following evaluation criteria.

### [Evaluation Criteria]

A: The gamut is more than 350,000.
B: The gamut is more than 320,000 and not more than 350,000.
C: The gamut is more than 290,000 and not more than 320,000.
D: The gamut is not more than 290,000.

### 4. Evaluation Results

As can be seen from the evaluation results in FIGS. 1A through 2D, the recorded products of Examples 1 to 23 were superior in coloration, dry rub fastness, and wet rub fastness to the recorded products of Comparative Examples 1 to 17 which were each produced with the use of a coating liquid composition containing the emulsified particles in an amount of not more than 15.0% by mass. In particular, the data indicates that any one of the recorded products of Examples 1 to 23, having a particular resolution (e.g., 1200×1200), had better coloration than a corresponding one (s) of the recorded products of Comparative Examples 1 to 17, having the particular resolution. The data also indicates that the recorded products of Examples 24 and 25 were superior in gamut to the recorded products of Comparative Examples 18 and 19 which were each produced with the use of a coating liquid composition containing the emulsified particles in an amount of not more than 15.0% by mass.

What is claimed is:

1. A coating liquid composition for pigment printing, comprising emulsified particles containing a silicone oil, and water, wherein the content of the emulsified particles is more than 15.0% by mass based on the total amount of the coating liquid composition for pigment printing.

2. The coating liquid composition for pigment printing according to claim 1, wherein the content of the emulsified particles is not more than 40.0% by mass based on the total amount of the coating liquid composition.

3. The coating liquid composition for pigment printing according to claim 1, further comprising a crosslinking agent.

4. The coating liquid composition for pigment printing according to claim 1, further comprising an organic solvent, wherein the content of the organic solvent is not more than 10.0% by mass based on the total amount of the coating liquid composition.

5. A recording method comprising a coating step of applying the coating liquid composition for pigment printing according to claim 1 onto an image formed on a recording medium.

6. The recording method according to claim 5, wherein in the coating step, the application of the coating liquid composition is performed by a padding method, a dipping method, a coating method, or an ink jet method.

7. The recording method according to claim 5, further comprising a drying step of drying the coating liquid composition for pigment printing applied to the recording medium.

8. The recording method according to claim 5, wherein the recording medium is a blended fabric.

9. The recording method according to claim 5, further comprising a pretreatment step of applying and attaching a pretreatment liquid to the recording medium.

10. A recorded product comprising an overcoat layer formed from the coating liquid composition for pigment printing according to claim 1, wherein the recorded product has a diffuse reflectance of less than 3 in the wavelength range of 300 to 800 nm.
